(19) United States
(12) Patent Application Publication
(10) Pub. No.: US 2022/0411166 A1
(43) Pub. Date: Dec. 29, 2022

(54) IMPACT SAFE LIGHTWEIGHT FLOATING COOLER DEVICE

(71) Applicant: Galen Mudd, Ontario, CA (US)

(72) Inventor: Galen Mudd, Ontario, CA (US)

(21) Appl. No.: 17/902,515

(22) Filed: Sep. 2, 2022

Related U.S. Application Data
(63) Continuation of application No. 17/015,720, filed on Sep. 9, 2020.

(51) Int. Cl. B65D 81/38; F25D 3/06; B65D 53/00; B65D 51/24; B65D 43/16

(52) U.S. Cl. CPC B65D 81/3816; F25D 3/06; B65D 53/00; B65D 51/24; B65D 43/16

(57) ABSTRACT

The impact safe lightweight floating cooler device disclosed herein may provide a buoyant and resilient cooler device that may also be safe for a user that could be hit by the device. To be more specific, a user traversing tumultuous waters or rapids, who also wishes to carry with them their food or drinks in a cooler, has no viable option known in the art that meets their needs. The needs of such users, in particular, may be that the device must be resilient and reusable, buoyant and stable, and also impact safe and wear resistant. To achieve these ends the device may comprise a foam core comprising a concave base for buoyancy and improved balance. The foam core may also provide an impact safe and impact resistant design. The device may comprise a lid for accessing its central cavity, and the lid itself may comprise silicone-covered magnets for providing a watertight seal. The side walls of the main body may comprise multiple layers for added functionality.

### TECHNICAL FIELD OF THE INVENTION

The present invention relates in general to food and drink storage, and, more specifically, to an impact safe lightweight floating cooler device.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

A food and drinks cooler, which may also be known as a portable ice chest, an ice box, a cool box, or a chilly bin, is an insulated container designed for keeping food and drinks cold. Such devices often comprise shells of plastic having a foam insulating layer, and are made available in a large variety of sizes, shapes, and designs. By way of example, a number of coolers may be provided in a generally cuboid shape having an articulating upper lid for accessing the central cavity, and may include a pair of wheels along with lifting handles for ease of transportation. Yet other coolers may be provided in a generally cylindrical shape having a removeable upper lid combined with a fluid spout for dispensing liquids. Some coolers are provided in entirely polystyrene shells so that they may be disposable, while other coolers may be provided with soft-sided materials so that they may be lightweight and easy to carry.

The shape and composition of coolers varies based on their intended purpose and usage. One specific type of cooler may be a floating cooler, which may comprise buoyant properties by virtue of its foam core and hollow interior, or which may induce buoyancy by virtue of its design. By way of example, it is known in the art to have a floating device, which may comprise an inflatable plastic main body, that may receive and float a separate cooler. By way of another example, it is known in the art to have coolers that integrate both the floating device and a central cavity that may receive cooling materials along with food and drinks. The issue with both such devices, though, is that they are required to be inflated and do not comprise the foam core needed for adequate insulation of foods and drinks.

Yet another design known in the art may incorporate a plastic and foam core construction having an air bladder allowing it to float. Such a design may be spherical or generally cylindrical, and may receive cooling materials along with food and drinks in a central cavity. The problem with such designs, though, is that they tend to be unstable in water and are easily toppled over. Further, the solid exterior material of such designs makes them impact resistant, but also makes them dangerous to a person that may be hit by the cooler.

No solution exists that provides a buoyant and resilient cooler device that may also be safe for a user that could be hit by the device. To be more specific, a user traversing tumultuous waters or rapids, who also wishes to carry with them their food or drinks in a cooler, has no viable option known in the art that meets their needs. The needs of such users, in particular, may be that the device must be resilient and reusable, buoyant and stable, and also impact safe and wear resistant.

Thus, there is a need in the art for an impact safe lightweight floating cooler device that may allow a user to operate in choppy water or rapids without toppling over, and without presenting a risk of injury to a user that may be hit by the device. It is to these ends that the present invention has been developed.

### BRIEF SUMMARY OF THE INVENTION

To minimize the limitations in the prior art, and to minimize other limitations that will be apparent upon reading and understanding the present specification, the present invention describes an impact safe lightweight floating cooler device.

It is an objective of the present invention to provide an impact safe lightweight floating cooler device that may comprise a cooler.

It is another objective of the present invention to provide an impact safe lightweight floating cooler device that may comprise a floating main body.

It is another objective of the present invention to provide an impact safe lightweight floating cooler device that may comprise a stabilizing concavity.

It is another objective of the present invention to provide an impact safe lightweight floating cooler device that may comprise a hinged lid.

It is another objective of the present invention to provide an impact safe lightweight floating cooler device that may comprise a lid frame.

It is another objective of the present invention to provide an impact safe lightweight floating cooler device that may comprise a multi-layer construction.

It is another objective of the present invention to provide an impact safe lightweight floating cooler device that may comprise an inner waterproof layer.

It is another objective of the present invention to provide an impact safe lightweight floating cooler device that may comprise a middle insulating layer.

It is another objective of the present invention to provide an impact safe lightweight floating cooler device that may comprise an outer decorative layer.

It is another objective of the present invention to provide an impact safe lightweight floating cooler device that may comprise an outer protective layer.

It is another objective of the present invention to provide an impact safe lightweight floating cooler device that may comprise a plurality of cup holders.

It is another objective of the present invention to provide an impact safe lightweight floating cooler device that may comprise a locking latch.

It is another objective of the present invention to provide an impact safe lightweight floating cooler device that may comprise a magnetic seal.

It is another objective of the present invention to provide an impact safe lightweight floating cooler device that may comprise an insulating seal.

It is another objective of the present invention to provide an impact safe lightweight floating cooler device that may comprise a resilient material of construction.

It is another objective of the present invention to provide an impact safe lightweight floating cooler device that may comprise a water-proof material of construction.

It is another objective of the present invention to provide an impact safe lightweight floating cooler device that may comprise a reusable material of construction.

It is another objective of the present invention to provide an impact safe lightweight floating cooler device that may comprise a washable material of construction.

It is another objective of the present invention to provide an impact safe lightweight floating cooler device that may comprise a multi-component construction.

It is another objective of the present invention to provide an impact safe lightweight floating cooler device that may comprise an antimicrobial layer.

It is another objective of the present invention to provide an impact safe lightweight floating cooler device that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is an upper isometric perspective view of an impact safe lightweight floating cooler device, as contemplated by the present disclosure;

FIG. 2 is a lower isometric perspective view of an impact safe lightweight floating cooler device, as contemplated by the present disclosure;

FIG. 3 is a side elevation view of an impact safe lightweight floating cooler device, as contemplated by the present disclosure;

FIG. 4 is an upper isometric perspective view of an impact safe lightweight floating cooler device with lid opened, as contemplated by the present disclosure;

FIG. 5 is an upper isometric perspective view of an impact safe lightweight floating cooler device with lid opened, as contemplated by the present disclosure;

FIG. 6 is an upper rear isometric perspective view of an impact safe lightweight floating cooler device with lid opened, as contemplated by the present disclosure;

FIG. 7 is an upper rear isometric perspective view of an impact safe lightweight floating cooler device with lid opened, as contemplated by the present disclosure;

FIG. 8 is a front elevation view of an impact safe lightweight floating cooler device with lid opened, as contemplated by the present disclosure;

FIG. 9 is a left side elevation view of an impact safe lightweight floating cooler device with lid opened, as contemplated by the present disclosure;

FIG. 10 is a cross-sectional view of a first embodiment of an impact safe lightweight floating cooler device, as contemplated by the present disclosure; and

FIG. 11 is a cross-sectional view of a second embodiment of an impact safe lightweight floating cooler device, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The impact safe lightweight floating cooler device may provide a buoyant and resilient cooler device that may also be safe for a user that could be hit by the device. To be more specific, a user traversing tumultuous waters or rapids, who also wishes to carry with them their food or drinks in a cooler, has no viable option known in the art that meets their needs. The needs of such users, in particular, may be that the device must be resilient and reusable, buoyant and stable, and also impact safe and wear resistant. To achieve these ends the device may comprise a foam core comprising a concave base for buoyancy and improved balance. The foam core may also provide an impact safe and impact resistant design. The device may comprise a lid for accessing its central cavity, and the lid itself may comprise silicone-covered magnets for providing a watertight seal. The side walls of the main body may comprise multiple layers for added functionality.

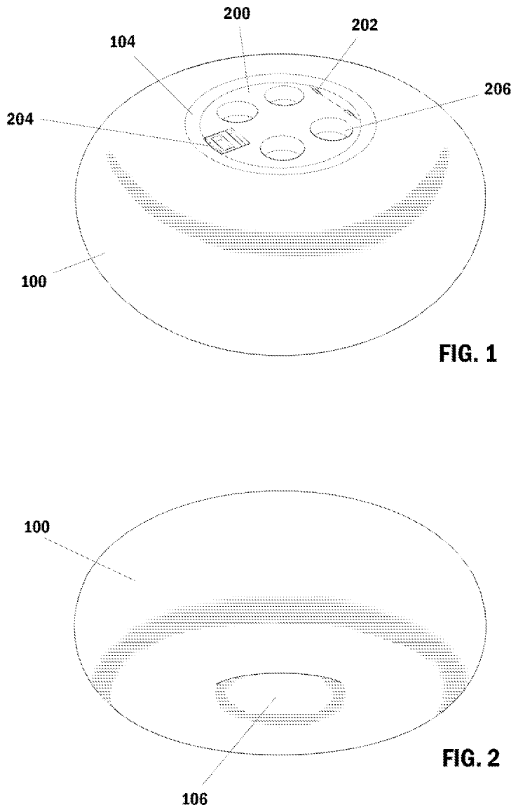

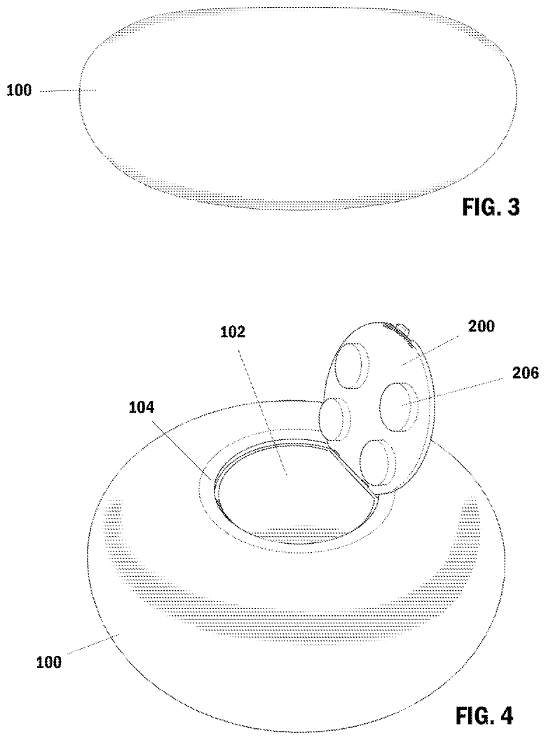

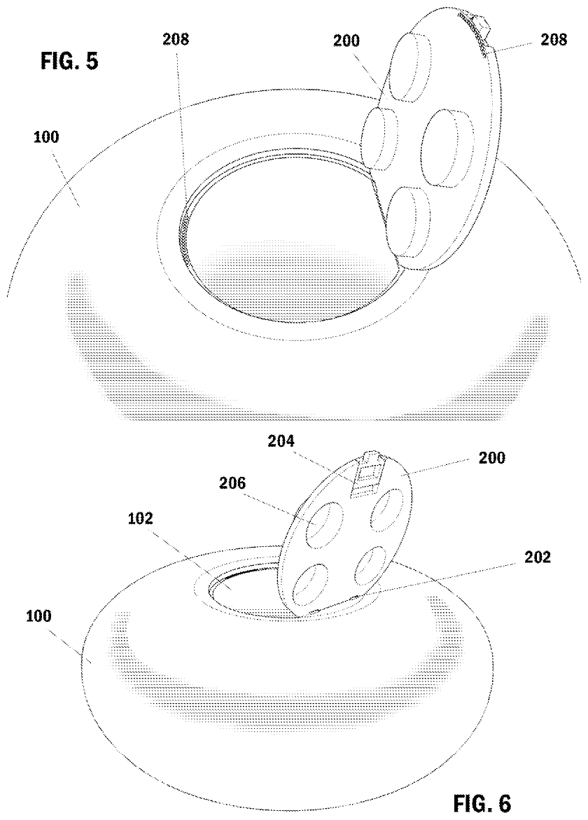

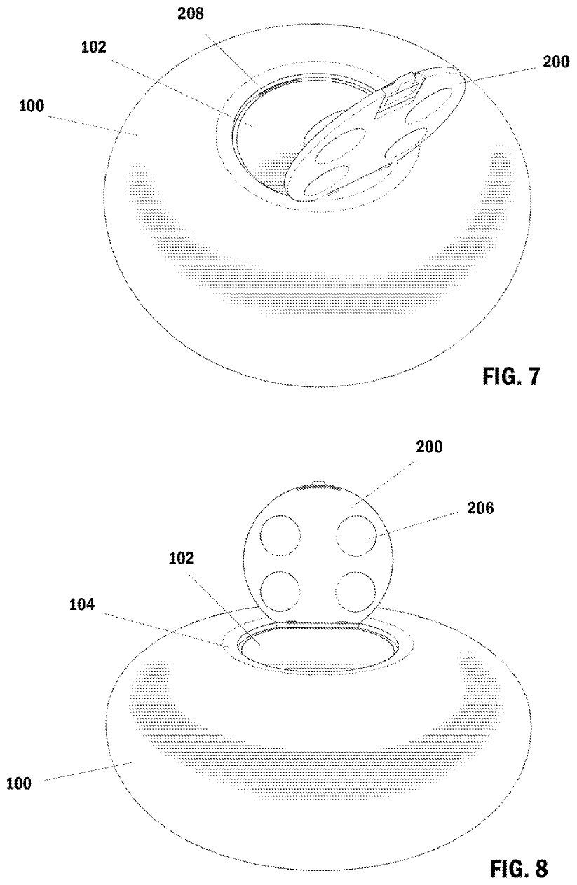

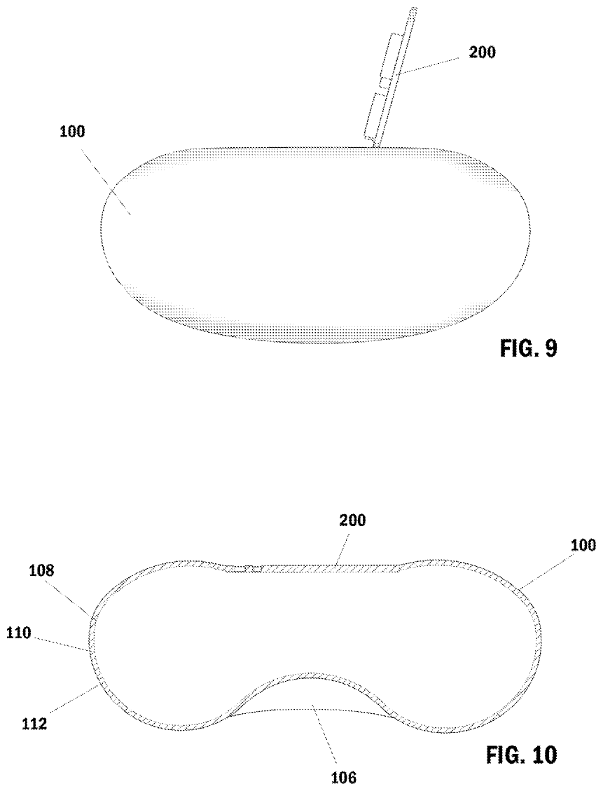

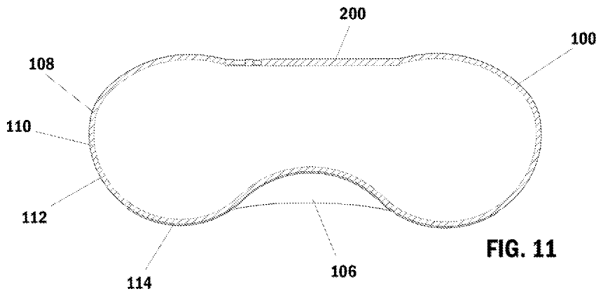

The illustrations of FIGS. 1-11 illustrate an impact safe lightweight floating cooler device, as contemplated by the present disclosure. The device may comprise, generally, a main body 100 and a lid 200. The main body 100 is intended to provide a lightweight and impact safe container that is both buoyant and stable on water, while the lid 200 is intended to allow a user to access the central cavity 102 of the main body 100.

The main body 100 may comprise any appropriate hollow shape having a volume and a central cavity 102. In one embodiment the main body 100 may comprise a shape having no corners or sharp edges to improve the impact safety of the device. In one embodiment the main body 100 may comprise a spherical or flattened spherical shape so as to maximize internal volume relative to perimeter material, and may comprise, generally, an upper side and a lower side. The lower side of the main body 100 may further comprise a lower concavity 106, which may be a depression or indentation in the main body 100 relative to the lower side. In this way the main body 100 may be placed in or on a water surface with the lower side down, and the central concavity 106 may remain above or out of the water. Such a mechanism may help to improve the buoyancy of the device by creating suction on the water and by acting as a multi-hull design.

The perimeter wall of the main body 100 may comprise any appropriate material of construction and may comprise a multi-layer design having an inner layer 108, a middle layer 110, and outer layer 112, and a protective layer 114. The inner layer 108, which may comprise the most proximal layer of the perimeter wall of the main body 100, may comprise any appropriate material of construction providing an inner waterproof lining and insulating layer. The middle layer 110, which may comprise the primary structural layer of the perimeter wall of the main body 100, may comprise any appropriate material of construction providing structural rigidity and insulation. The outer layer 112, which may comprise the most distal layer of the perimeter wall of the main body 100, may comprise any appropriate material of construction providing an outer waterproof lining, wear resistance, and a decorative surface. In one embodiment the perimeter wall of main body 100 may further comprise a protective layer 114, which may comprise any appropriate material of construction providing an outer waterproof lining and wear resistance.

By way of example, the inner layer 108 may comprise a plastic interior layer for its lightweight and waterproof characteristics. The inner layer 108 may instead comprise a metal, such as an aluminum or steel inner layer, which may provide enhanced cooling characteristics though at the expense of increased weight and reduced safety.

The middle layer 110 may comprise a foam such as, for example, thermoplastic polyurethane or expanded polystyrene, for its buoyant properties, insulating properties, light weight, impact safety, and impact resistance. The middle layer 110 may instead comprise a hollow vinyl, such as that used in rescue buoys, Peterson tubes, and Burnside buoys, which has an increased buoyancy and lighter weight, though at the expense of increased rigidity.

The outer layer 112 may comprise a hard plastic or vinyl outer layer for its lightweight and waterproof characteristics, as well as its decorative properties. The outer layer 112 may also comprise damage resistant properties to provide longevity to the device, and may be decorated as desired for various purposes.

The protective layer 114 may comprise a relatively thicker hard plastic or vinyl outer layer for its damage resistant properties, and may be placed only on the lower side of the main body 100 so as to provide increased damage resistance to the bottom side of the device.

The upper side of the main body 100 may comprise an opening that allows a user to access the hollow central cavity 102 of the main body 100. The opening may be any appropriate shape, and may be lined by a lid frame 104, which may comprise a relatively harder material than the main body 100, and which may act as a support and sealing structure for the lid 200. The mechanism of attachment of the lid frame 104 to the main body 100 may be by any appropriate physical means such as, for example, inserting, bolting, snapping, gluing, binding, or the like.

The lid 200 may be articulably attached to the lid frame 104 such that is may act as a cover for the central cavity 102 when the lid 200 is closed against the lid frame 104, and may permit access to the central cavity 102 when articulated away from the lid frame 104. The mechanism of attachment of the lid 200 to the lid frame 104 may be by any appropriate physical means such as, for example, inserting, bolting, snapping, gluing, binding, or the like. In one embodiment the mechanism of attachment of the lid 200 to the lid frame 104 may be by a hinge 202.

The hinge 202 may comprise any appropriate hinge known in the art such as, for example, a piano hinge, butt hinge, spring-loaded hinge, concealed hinge, offset hinge, or the like. The hinge 202 may comprise any appropriate hinge permitting relative movement of two components through an arced range of motion while limiting the minimum or maximum arc range or locking the two components into a relative position at either limit.

The lid 200 may further comprise a latch 204, which may allow the locking and unlocking of the lid 200 relative to the lid frame 104. The latch 204 may comprise any appropriate latch known in the art such as, for example, a slam latch, deadbolt latch, spring latch, cam and twist latch, hook latch, or the like. The latch 204 may further comprise any appropriate locking mechanism for securing the lid 200 to the lid frame 104 such as, for example, a keyed lock, fastener, catch, padlock receiver, or the like.

The lid 200 may further comprise a plurality of cup holders 206, which may comprise appropriately shaped recesses or depressions within the lid 200 into which a standard cup or can may be placed and held.

The impact safe lightweight floating cooler device may further comprise a plurality of magnetic seals 208, which may be a plurality of magnets or magnetic materials embedded in a silicone strip. One each of the plurality of magnetic seals 208 may be installed on a ledge attached to the lid frame 104 and on an inner side of the lid 200 such that when the lid 200 is closed against the lid frame 104 the two of the plurality of magnetic seals 208 are magnetically bound to each other, and their respective silicone strips press against one another to form a watertight seal.

The main body 100 may further comprise any appropriate accessories or modifications for providing additional functionality to the impact safe lightweight floating cooler device. In one embodiment the main body 100 may further comprise an attachment point or anchor for attaching a tow rope or similar component to the device.

In one embodiment the main body 100 may further comprise a handgrip, which may be any appropriate structure for lifting, pushing, or pulling the impact safe lightweight floating cooler device.

In one embodiment the main body 100 may further comprise a storage area, which may be any appropriate pocket or container for providing storage space or storage areas within or on the device.

In one embodiment the main body 100 may further comprise a plurality of cargo netting, which may be any appropriate material for preventing materials falling from, off, or through the device.

The impact safe lightweight floating cooler device may be substantially constructed of any suitable material or combination of materials, but typically is constructed of a resilient material or combination of materials such that the device is resistant to damage as a result of compression, twisting, heating, or submersion in water. As an example, and without limiting the scope of the present invention, various exemplary embodiments of the impact safe lightweight floating cooler device may be substantially constructed of one or more materials of silicone, plastic, acrylic, polycarbonate, steel, aluminum, brass, magnetic metals, fiberglass, carbon fiber, or combinations thereof. In some embodiments the various components of the device may be coated, lined, or otherwise insulated to prevent contamination of the device. In one embodiment the material of construction may vary from one component to the next within the system.

In one embodiment the impact safe lightweight floating cooler device may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. An impact safe lightweight floating cooler device, comprising:
a main body;
a lid frame;
a lid;
an attachment mechanism;
a latching mechanism; and
a sealing mechanism;
wherein said main body comprises a fixed shape;
wherein said main body comprises a hollow container having a perimeter wall, an upper side, a lower side, and a lateral perimeter;
wherein said perimeter wall of said main body further comprises an inner layer, a middle layer, and an outer layer;
wherein said upper side of said main body further comprises an opening;
wherein said lower side of said main body further comprises a concavity;
wherein said lid frame is attached to said opening of said upper side of said main body;
wherein said lid is removably attached to said lid frame via said attachment mechanism;
wherein said latching mechanism is attached to said lid;
wherein said latching mechanism is removably attached to said lid frame when said lid is closed against said lid frame;
wherein said sealing mechanism is positioned between said lid and said lid frame when said lid is closed against said lid frame;
wherein said concavity comprises a depression in said lower side of said main body that creates a multi-hull design; and
wherein said depression of said concavity creates a suction force when the device is placed on water.

2. The impact safe lightweight floating cooler device of claim 1,
wherein said sealing mechanism comprises a plurality of magnetic seals;
wherein one of said plurality of magnetic seals is attached to said lid frame;
wherein one of said plurality of magnetic seals is attached to said lid;
wherein said one of said plurality of magnetic seals attached to said lid frame magnetically attaches to said one of said plurality of magnetic seals attached to said lid when said lid is closed against said lid frame; and
wherein said plurality of magnetic seals create a watertight seal when magnetically attached.

3. The impact safe lightweight floating cooler device of claim 2,
wherein said plurality of magnetic seals comprise a plurality of silicone-embedded magnets.

4. The impact safe lightweight floating cooler device of claim 3, further comprising:
a plurality of cup holders;
wherein said plurality of cup holders are installed within said lid.

5. The impact safe lightweight floating cooler device of claim 4, further comprising:
a protective layer;
wherein said protective layer is attached to said lower side of said main body.

6. The impact safe lightweight floating cooler device of claim 5,
wherein said attachment mechanism is a hinge mechanism.

7. The impact safe lightweight floating cooler device of claim 6,
wherein said latching mechanism is a spring-loaded latch mechanism.

8. The impact safe lightweight floating cooler device of claim 6,
wherein said inner layer comprises an inner insulating layer.

9. The impact safe lightweight floating cooler device of claim 6,
wherein said middle layer comprises a foam core.

10. The impact safe lightweight floating cooler device of claim 6,
wherein said middle layer comprises a hollow vinyl core.

11. The impact safe lightweight floating cooler device of claim 6,
wherein said outer layer comprises a vinyl wrap.
